(19) United States
(12) Patent Application Publication
(10) Pub. No.: US 2013/0110260 A1
(43) Pub. Date: May 2, 2013

(54) CONTROL SYSTEM FOR ELECTRICITY TRANSFER DEVICE AND RELATED SYSTEMS AND METHODS

(71) Applicants: Carmelo A. Carpinteri, Phoenix, AZ (US); Robert Page, Phoenix, AZ (US); Garrett Beauregard, Phoenix, AZ (US); Andrew Warwick Hooper, San Francisco, CA (US)

(72) Inventors: Carmelo A. Carpinteri, Phoenix, AZ (US); Robert Page, Phoenix, AZ (US); Garrett Beauregard, Phoenix, AZ (US); Andrew Warwick Hooper, San Francisco, CA (US)

(73) Assignee: Electric Transporation Engineering Corporation, d/b/a ECOtality North America, Phoenix, AZ (US)

(21) Appl. No.: 13/282,306

(22) Filed: Oct. 26, 2011

(51) Int. Cl. G05B 11/01

(52) U.S. Cl. 700/20

(57) ABSTRACT

Some embodiments include a control system for an electricity transfer device. Other embodiments of related systems and methods are also disclosed.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to a control system for an electricity transfer device, and relates more particularly to such control systems for wirelessly operating electric vehicle charging stations and to related systems and methods.

### DESCRIPTION OF THE BACKGROUND

Advances in electric vehicle technologies continue to improve the experience of operating electric vehicles by reducing inconveniences posed to electric vehicle operators compared to internal combustion vehicle operators. Nonetheless, providing electricity to the rechargeable energy storage systems of electric vehicles still introduces undesirable inconveniences to electric vehicle operators that internal combustion vehicle operators do not experience at all or experience to a lesser extent. Accordingly, a need or potential for benefit exists for a control system and related systems and methods that allow for more convenient operation of electricity transfer devices for electric vehicles.

### BRIEF DESCRIPTION OF THE DRAWINGS

To facilitate further description of the embodiments, the following drawings are provided in which:

FIG. 1 illustrates a representative block diagram of a control system, according to an embodiment;

FIG. 2 illustrates a flow chart for an embodiment of a method for providing a control system;

FIG. 3 illustrates an exemplary procedure of providing a communication module configured to provide wireless communication of the control system with an electricity transfer device, according to the embodiment of FIG. 2;

FIG. 4 illustrates an exemplary process of providing an authentication module configured to administer authentication of the control system in order to establish the wireless communication of the control system with the electricity transfer device, according to the embodiment of FIGS. 2 and 3;

FIG. 5 illustrates a flow chart for an embodiment of a method of operating an electricity transfer device;

FIG. 6 illustrates an exemplary procedure of permitting a user of a control system to operate the electricity transfer device with the control system at a mobile electronic device, according to the embodiment of FIG. 5;

FIG. 7 illustrates an exemplary procedure of providing information to the user at a control system interface of the control system at the mobile electronic device, according to the embodiment of FIG. 5;

FIG. 8 illustrates an exemplary procedure of permitting an other user of an other control system to operate the electricity transfer device with the other control system at an other mobile electronic device, according to the embodiment of FIG. 5;

FIG. 9 illustrates an exemplary procedure of providing information to the other user at an other control system interface of the other control system at the other mobile electronic device, according to the embodiment of FIG. 5;

FIG. 10 illustrates a representative block diagram of a system, according to an embodiment;

FIG. 11 illustrates a flow chart for an embodiment of a method of providing a system;

FIG. 12 illustrates a computer system that is suitable for implementing an embodiment of a mobile electronic device computer system, a remote computer system, and/or an electricity transfer device computer system, according to the embodiments of FIGS. 1-11; and

FIG. 13 illustrates a representative block diagram of exemplary components and/or circuitry included in exemplary circuit boards inside a chassis of the computer system of FIG. 12.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

Some embodiments include a control system configured to be run on one or more processors of a mobile electronic device computer system of a mobile electronic device and storable at one or more memory storage units of the mobile electronic device computer system. The control system comprises a communication module. The communication module can be configured to provide wireless communication of the control system with an electricity transfer device. Meanwhile, the communication module comprises an authentication module, and the authentication module can be configured to administer authentication of the control system in order to establish the wireless communication of the control system with the electricity transfer device. The control system also comprises a control system interface. The control system interface can be configured to permit a user of the control system to operate the control system at the mobile electronic device and can be further configured to provide information to the user of the control system at the mobile electronic device. Also, the control system can comprise an executive mode. Meanwhile, the control system can be configured to permit the user (a) to control the electricity transfer device and (b) to monitor electricity transfer status of the electricity transfer device at the mobile electronic device and/or to reserve use of the electricity transfer device with the control system, when the control system is wirelessly communicating with the electricity transfer device and when the control system is operating in the executive mode.

Various embodiments include a method for providing a control system. The control system can be configured to be run on one or more processors of a mobile electronic device computer system of a mobile electronic device and storable at one or more memory storage units of the mobile electronic device computer system. The method can comprise: providing a communication module configured to provide wireless communication of the control system with an electricity transfer device, where providing the communication module comprises providing an authentication module configured to administer authentication of the control system in order to establish the wireless communication of the control system with the electricity transfer device; providing a control system interface configured to permit a user of the control system to operate the control system at the mobile electronic device and configured to provide information to the user of the control system at the mobile electronic device; and configuring the control system to comprise an executive mode to permit the user (a) to control the electricity transfer device with the control system and (b) to monitor an electricity transfer status of the electricity transfer device at the mobile electronic device and/or to reserve use of the electricity transfer device with the control system, when the control system is wirelessly communicating with the electricity transfer device and when the control system is operating in the executive mode.

Further embodiments include a method of operating an electricity transfer device. The electricity transfer device can be configured to be controlled by a control system, and the control system can be configured to be run on one or more processors of a mobile electronic device computer system of a mobile electronic device and storable at one or more memory storage units of the mobile electronic device computer system. The method can comprise: establishing wireless communication of the electricity transfer device with the control system, where establishing wireless communication of the electricity transfer device with the control system comprises receiving a request to authenticate the control system; after establishing wireless communication of the electricity transfer device with the control system, permitting a user of the control system to operate the electricity transfer device with the control system at the mobile electronic device, where permitting the user of the control system to operate the electricity transfer device comprises instructing the control system to operate in an executive mode; and after establishing wireless communication of the electricity transfer device with the control system, providing information to the user at a control system interface of the control system at the mobile electronic device.

Still further embodiments include a system. The system comprises an electricity transfer device. The electricity transfer device can be configured to be operated by a control system, and the control system can be configured to be run on one or more processors of a mobile electronic device computer system of a mobile electronic device and storable at one or more memory storage units of the mobile electronic device computer system. Meanwhile, the electricity transfer device can comprise a communication module, and the communication module can be configured to provide wireless communication of the electricity transfer device with the control system. The system can also comprise a remote computer system located remotely from the electricity transfer device and the mobile electronic device. Likewise, the system can comprise an authentication module configured to administer authentication of the control system. The authentication module can be located at one of the electricity transfer device or the remote computer system. Meanwhile, the electricity transfer device can be configured to be operable by a user of the control system via the control system when the control system is authenticated and when the electricity transfer device is wirelessly communicating with the control system. Furthermore, the electricity transfer device and/or the remote computer system can be configured to provide information to the user at a control system interface of the control system at the mobile electronic device when the control system is authenticated and when the electricity transfer device is wirelessly communicating with the control system.

Other embodiments include a method of providing a system. The method can comprise: providing an electricity transfer device, where the electricity transfer device can be configured to be operated by a control system, the control system can be configured to be run on one or more processors of a mobile electronic device computer system of a mobile electronic device and storable at one or more memory storage units of the mobile electronic device computer system, and the electricity transfer device can comprise a communication module configured to provide wireless communication of the electricity transfer device with the control system; providing a remote computer system located remotely from the electricity transfer device and the mobile electronic device; providing an authentication module configured to administer authentication of the control system such that one of the electricity transfer device or the remote computer system comprises the authentication module; configuring the electricity transfer device to be operable by a user of the control system via the control system when the control system is authenticated and when the electricity transfer device is wirelessly communicating with the control system in either one of an executive mode or a subordinate mode; and configuring the electricity transfer device such that the electricity transfer device and/or the remote computer system is able to provide information to the user at a control system interface of the control system at the mobile electronic device when the control system is authenticated and when the electricity transfer device is wirelessly communicating with the control system in either one of the executive mode or the subordinate mode.

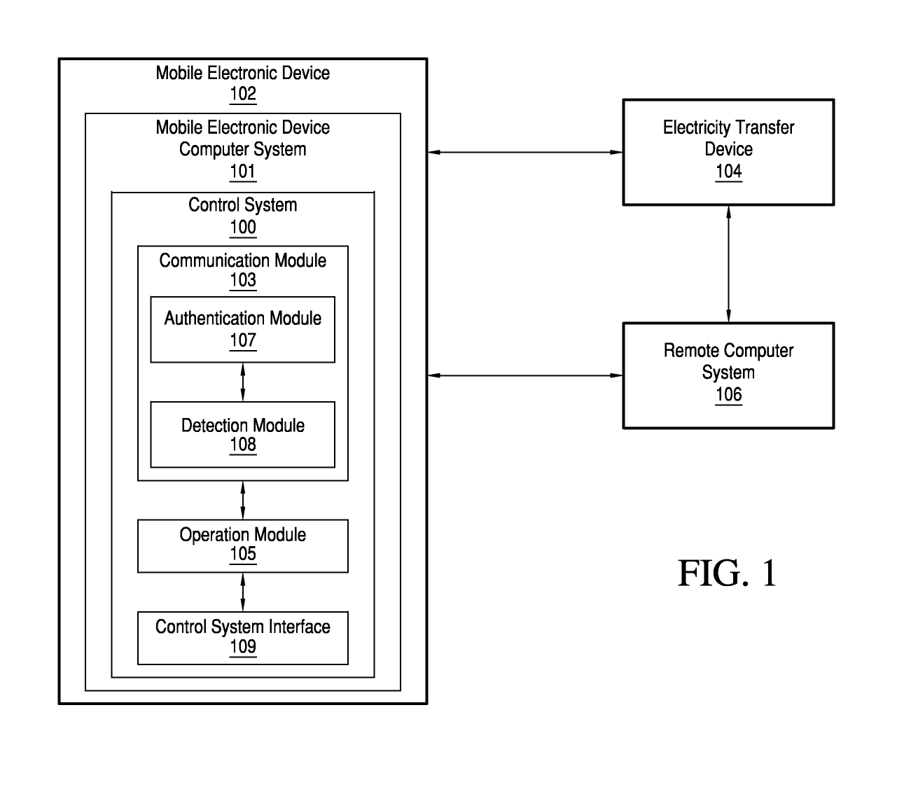

Turning to the drawings, FIG. 1 illustrates a representative block diagram of control system 100, according to an embodiment. Control system 100 can be configured to be run on one or more processors of mobile electronic device computer system 101 of mobile electronic device 102 and storable at one or more memory storage units of mobile electronic device computer system 101. Control system 100 is merely exemplary and is not limited to the embodiments presented herein. Control system 100 can be employed in many different embodiments or examples not specifically depicted or described herein.

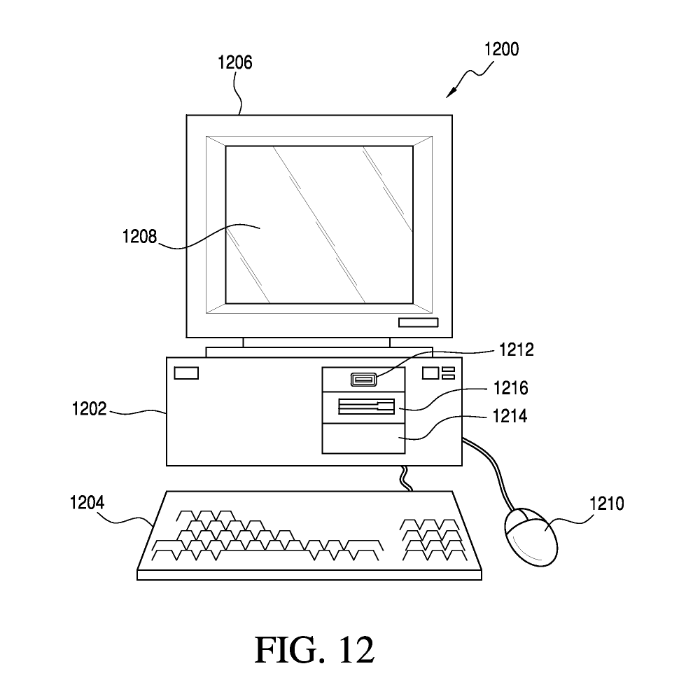

Control system 100 can be configured to operate and/or can be implemented as application software of mobile electronic device computer system 101. Accordingly, in some embodiments, control system 100 can be bundled with mobile electronic device computer system 101 or, in other embodiments, can be downloaded from another computer system (e.g., remote computer system 106). As application software, control system 100 can be configured to wirelessly operate electricity transfer device 104 and/or to wirelessly communicate with remote computer system 106 of a device network comprising one or more other electricity transfer devices in addition to electricity transfer device 104. Remote computer system 106 and the device network will be discussed in further detail below. Mobile electronic device computer system 101 can be similar or identical to computer system 1200 (FIG. 12), as described below. Each of the other electricity transfer device(s) can be similar or identical to electricity transfer device 104.

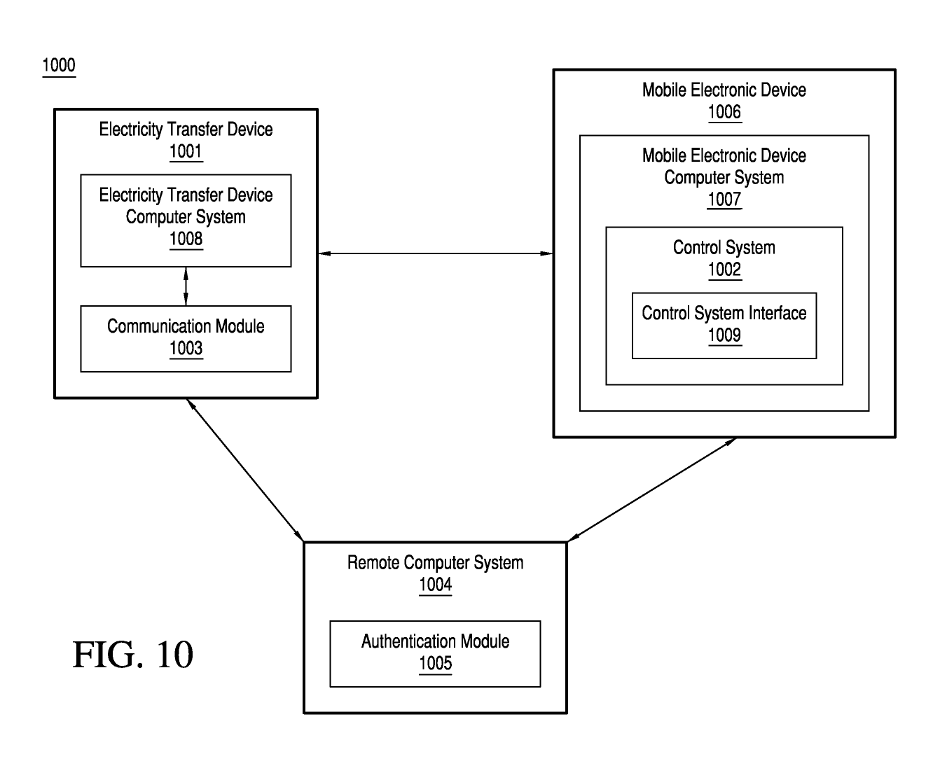

Although electricity transfer device 104 and the other electricity transfer device(s) may each comprise any of various operational components (e.g., an electricity transfer device computer system (which may be similar or identical to electricity transfer device computer system 1008 (FIG. 10), as described below, an electricity transfer device interface, and/or other electricity transfer device circuitry, etc.) configured to permit user(s) of electricity transfer device 104 and/or the other electricity transfer device(s) to operate electricity transfer device 104 and the other electricity transfer device(s), respectively, control system 100 can replace and/or supplement the operational components of one of electricity transfer device 104 and the other electricity transfer device(s) such that any of electricity transfer device 104 and/or the other electricity transfer device(s) may be thought of as a “headless” electricity transfer device when being operated by control system 100. Still, because in many embodiments, control system 100 merely supplements the operational components of the one of electricity transfer device 104 and/or the any other electricity transfer device(s), it can be understood that referencing electricity transfer device 104 and/or the other electricity transfer device(s) as being “headless” is merely intended for convenience of reference and does not necessarily denote a complete lack of a user interface at electricity transfer device 104 and/or the other electricity transfer devices. Still, it is possible that in some embodiments, control system 100 may indeed provide all operational management of the one of electricity transfer device 104 and/or the other electricity transfer device(s), at least when control system 100 is operating the one of electricity transfer device 104 and the other electricity transfer device(s), such that the one of electricity transfer device 104 and/or the other electricity transfer devices (104) completely lack a user interface.

Using control system 100 to replace and/or supplement the operational components of the one of electricity transfer device 104 and the other electricity transfer device(s) can be advantageous when mobile electronic device computer system 101 and/or mobile electronic device 102 are configured to support enhanced functionality, computational processing capability, and/or computational memory storage capacity that is not supported by the operational components of electricity transfer device 104 and the other electricity transfer device(s). For example, mobile electronic device 102 may support video capability where the operational components of electricity transfer device 104 and the other electricity transfer device(s) may be limited to presenting still imagery or only text. Likewise, mobile electronic device 102 may comparably support any of audio capability, other video capability, networking capability, etc. not supported by the operational components of electricity transfer device 104 and the other electricity transfer device(s). Accordingly, control system 100 may enable enhanced control algorithms, video telephony (e.g., for troubleshooting and help), video advertising, or any number of other functions that would not ordinarily be available with electricity transfer device 104 and the other electricity transfer device(s) alone.

Meanwhile, in these or other embodiments, because control system 100 is configured to wirelessly communicate with the one of electricity transfer device 104 and the other electricity transfer device(s), using control system 100 to replace and/or supplement the operational components of the one of electricity transfer device 104 and the other electricity transfer device(s) can be advantageous where it is desirable to eliminate any wired coupling of a rechargeable energy storage system with the one of electricity transfer device 104 and the other electricity transfer device(s), such as, where the one of electricity transfer device 104 and/or the other electricity transfer device(s) are configured to transfer electricity wirelessly (e.g., inductively), and/or where the one of electricity transfer device 104 and/or the other electronic device(s) are located in inclement/inhospitable weather conditions. In this latter example, user(s) may be able to operate the one of electricity transfer device 104 and/or the other electricity transfer device(s) without ever leaving their electric vehicle.

Further still, control system 100 may be advantageous for hygienic purposes as user(s) can operate the one of electricity transfer device 104 and the other electricity transfer device(s) with their own personal mobile electronic device 102 and need not touch an electricity transfer device interface of the one of electricity transfer device 104 and the other electricity transfer device(s). Likewise, control system 100 may be subject to increased functionality as user(s) obtain new/updated ones of mobile electronic device 102 and/or new/updated ones of mobile electronic device computer system 101 without necessarily having to update and/or replace electricity transfer device 104 and the other electricity transfer device(s). Meanwhile, using control system 100 may permit electricity transfer device 104 to comprise less sophisticated components resulting in cost and/or carbon footprint reductions in production, and may permit electricity transfer device 104 to be designed more compactly and/or elegantly.

Mobile electronic device 102 can comprise any electronic device configured so as to be sufficiently portable to be carried by the user(s) of mobile electronic device 102 from one location to another without substantial difficulty. Accordingly, mobile electronic device 102 can comprise at least one of a digital music player, a digital video player, a mobile telephone such as a smart mobile telephone, a personal digital assistant, a handheld digital computer such as a tablet computer system, a laptop computer system, an electric vehicle computer system such as a carputer, or another any other comparable and/or suitable electronic device. For example, mobile electrical device 102 can comprise the iPod® or iPhone® or iTouch® or iPad® or MacBook® product by Apple Inc. of Cupertino, Calif. Likewise, mobile electrical device 102 can comprise a Blackberry® product by Research in Motion (RIM) of Waterloo, Ontario, Canada, or a different product by a different manufacturer.

Meanwhile, electricity transfer device 104 and the other electricity transfer device(s), when applicable, each can comprise an electric vehicle charging station. Each electric vehicle charging station can be configured to transfer electricity between a rechargeable energy storage system of an electric vehicle and a utility electric grid. In some embodiments, each electric vehicle charging station can be configured to make available and to provide electricity to charge a rechargeable energy storage system of an electric vehicle. In further embodiments, each electric vehicle charging station can also be configured to be able to receive electricity from the rechargeable energy storage system to provide the electricity to the utility electric grid, such as, for utility electric grid balancing. each of electricity transfer device 104 and the other electricity transfer device(s) may be similar or identical to each other.

The rechargeable energy storage system of the electric vehicle can comprise (a) one or more batteries and/or one or more fuel cells, (b) one or more capacitive energy storage systems (e.g., super capacitors such as electric double-layer capacitors), and/or (c) one or more inertial energy storage systems (e.g., one or more flywheels). In many embodiments, the one or more batteries can comprise one or more rechargeable (e.g., traction) and/or non-rechargeable batteries. For example, the one or more batteries can comprise one or more of a lead-acid battery, a valve regulated lead acid (VRLA) battery such as a gel battery and/or an absorbed glass mat (AGM) battery, a nickel-cadmium (NiCd) battery, a nickel-zinc (NiZn) battery, a nickel metal hydride (NiMH) battery, a zebra (e.g., molten chloroaluminate (NaAlCl₄)) and/or a lithium (e.g., lithium-ion (Li-ion)) battery. Meanwhile, the electric vehicle can comprise any full electric vehicle, any hybrid vehicle, and/or any other grid-connected vehicle. In the same or different embodiments, the electric vehicle can comprise any one of a car, a truck, motorcycle, a bicycle, a scooter, a boat, a train, an aircraft, an airport ground support equipment, and/or a material handling equipment (e.g., a fork-lift), etc.

In many embodiments, electricity transfer device 104 can be configured to be operated by multiple user(s) simultaneously. However, in these embodiments, electricity transfer device 104 may limit electricity transfer to one rechargeable energy storage system at a time due to electric power capacity of electricity transfer device 104 and/or of the power grid coupled to electricity transfer device 104. As a result, as will be described in further detail below, control system 100 can be configured to operate in different modes (e.g., an executive mode and/or a subordinate mode), for example, depending on whether control system 100 is operating electricity transfer device 104 in the capacity of a primary control system or a secondary control system. In some embodiments, control system 100 can have more than two modes.

Remote computer system 106 can be similar or identical to computer system 1200 (FIG. 12), as described below. As mentioned previously, remote computer system 106 can be configured to operate a device network comprising electricity transfer device 104 and the other electricity transfer device(s). Accordingly, as is detailed with respect to exemplary computer system 1200 (FIG. 12), remote computer system 106 can frequently be implemented as multiple computer systems operating in the capacity of a server to support the device network. In various embodiments, remote computer system 106 can be located remotely from electricity transfer device 104 and mobile electronic device 102. For example, remote computer system 106 may be located at one or more facilities operated by a managing entity of the device network.

The device network can be configured such that user(s) of the device network each can establish and maintain a user account with which he is associated. In many embodiments, by establishing a user account, the user(s) may each be granted access to use electricity transfer device 104 and the other electricity transfer device(s), such as, for charging his electric vehicle. The user account may comprise information pertaining to each individual user (e.g., personal information, charge preferences, etc.) and/or his electric vehicle (e.g., make/model/year, rechargeable energy storage system data, etc.) may account for his usage of any electricity transfer device(s) of the device network (e.g., for billing or other purposes), may provide data on usage patterns to the managing entity, etc. Accordingly, such user accounts can facilitate management and operation of the device network for the managing entity and the user(s). While in many embodiments, control system 100 can be provided by the managing entity of the device network, it is also possible that control system 100 could be provided by a third-party entity.

Referring now to FIG. 1, control system 100 comprises communication module 103, control system interface 109, and operation module 105. Communication module 103 comprises authentication module 107. Meanwhile, communication module 103 can also comprise detection module 108.

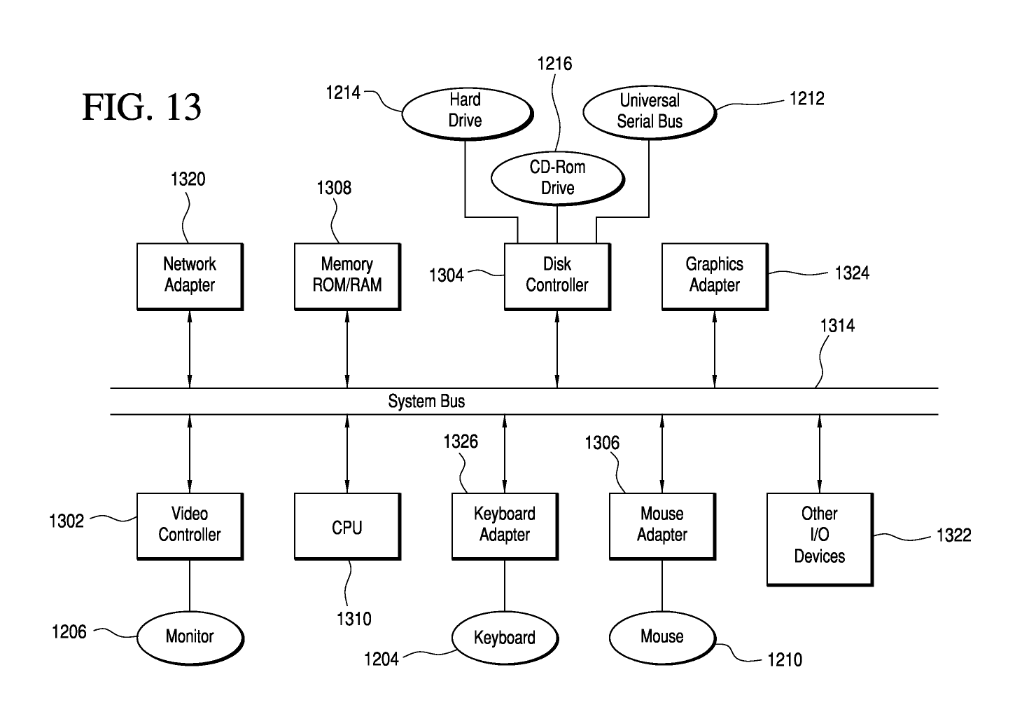

Communication module 103 can be configured to provide wireless communication between control system 100 and either or both of electricity transfer device 104 or remote computer system 106. Communication module 103 can be configured to implement a wireless network adapter (e.g., network adapter 1320 (FIG. 13)) of mobile electronic device computer system 101 to provide wireless communication of control system 100, according to any suitable wireless networking protocol. Exemplary wireless networking protocols can comprise wireless personal area network communication (e.g., Bluetooth, Zigbee, Wireless Universal Serial Bus (USB), Z-Wave, etc.), wireless local area network communication (e.g., Institute of Electrical and Electronic Engineers (IEEE) 802.11), wireless wide area network communication (e.g., IEEE 802.11), and/or wireless cellular network communication (e.g., Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc.). In other embodiments, communication module 103 can implement any radio transceiver and/or infrared transceiver of mobile electronic device 102 and/or mobile electronic device computer system 101 to provide wireless communication for control system 100. In many embodiments, communication module 103 can be configured to switch seamlessly between one wireless networking protocol to another depending on the distance of control system 100 to electricity transfer 104.

In some embodiments, communication module 103 can be configured to wirelessly communicate directly with electricity transfer device 104, for example, where communication module 103 is configured to wirelessly communicate via wireless personal area network communication and/or wireless local area network communication. In these embodiments, electricity transfer device 104 may then communicate with remote computer system 106 (when applicable), operating as an intermediary of communication between remote computer system 106 and communication module 103 (and mobile electronic device 102), or communication module 103 (and mobile electronic device 102) may operate as the intermediary of communication between remote computer system 106 and electricity transfer device 104. In other embodiments, communication module 103 can be configured to wirelessly communicate with electricity transfer device 104 indirectly through wireless communication with remote computer system 106, for example, such as by wireless wide area network communication or cellular telephone network communication. In these examples, remote computer system 106 operates as the intermediary of communication between communication module 103 (and mobile electronic device 102) and electricity transfer device 104. The manner of communication may depend on the communicative capabilities of mobile electronic device 102 and electricity transfer device 104 (and the other electricity transfer device(s), when applicable). In some embodiments, control system 100 can implement a combination of these communication structures, as desirable.

Authentication module 107 can be configured to administer authentication of control system 100 in order to establish wireless communication of control system 100 with electricity transfer device 104 and/or remote computer system 106. Accordingly, communication module 103 can be configured to provide wireless communication by control system 100 of electricity transfer device 104 and/or remote computer system 106 in order to permit authentication module 107 to administer authentication of control system 100. It can be understood that some degree of basic preliminary wireless communication may be necessary between control system 100 and electricity transfer device 104 and/or remote computer system 106 while authentication module 107 is initially establishing wireless communication between the same. Under these conditions, a user may be able to establish a user account where he does not already have one and/or to download control system 100 in order to use and/or authenticate his control system 100.

As part of administering authentication of control system 100, authentication module 107 can be configured to request authorization to establish wireless communication of control system 100 with electricity transfer device 104 and/or remote computer system 106. Authentication module 106 can be configured to wirelessly communicate with electricity transfer device 104 and/or remote computer system 106 to request authorization to establish the wireless communication of control system 100 with electricity transfer device 104 in order to prompt remote computer system 106 to determine if control system 100 is associated with a user account (as described with respect to the device network above) of the user of control system 100. When remote computer system 106 determines that control system 100 is associated with such a user account and when the user account is in good standing, remote computer system 106 may grant authorization to control system 100 to wirelessly communicate with electricity transfer device 104.

Authentication module 107 can be configured to administer authentication upon any suitable manual request initiated by the user(s) of control system 100 and/or automatically upon the occurrence of a predetermined condition. For example, authentication module 107 can be configured to administer authentication when the user(s) run control system 100, when the user(s) activate an authentication command control at control system interface 109, when the user(s) dial a telephone number associated with remote computer system 106, etc. In other examples, authentication module 107 can be configured to automatically administer authentication of control system 100 when detection module 108 detects electricity transfer device 104.

Accordingly, detection module 108 can be configured to detect electricity transfer device 104. For example, detection module 108 can be configured to detect a signal (e.g., a radio signal, a magnetic field, etc.) output by electricity transfer device 104. In other embodiments, detection module 108 can be configured to implement a global positioning system of mobile electronic device 102 to orient control system 100 with respect to electricity transfer device 104. In these examples, detection module 108 can consider electricity transfer device 104 as being detected when control system 100 passes within a certain distance (e.g., one meter, two meters, five meters, ten meters, etc.) of electricity transfer device 104.

Control system interface 109 can be configured to permit the user(s) of control system 100 to operate control system 100 at mobile electronic device 102 when communication module 103 is wirelessly communicating with electricity transfer device 104. In the same or different embodiment, control system interface 109 can be configured to provide information to user(s) of control system 100 at mobile electronic device 102 (e.g., via text message, via electronic mail, via telephone call, and/or via control system interface 109) when communication module 103 is wirelessly communicating with electricity transfer device 104.

Control system interface 109 can comprise a graphical user interface configured to be presented at an electronic display (e.g., a touch screen electronic display) of mobile electronic device 102. Further still, control system interface 109 can comprise one or more auditory outputs presented by one or more speakers of control system interface 109.

Operation module 105 can be configured to communicate with communication module 103 and control system interface 109. Accordingly, operation module 105 can administer communication between communication module 103 and control system interface 109. Meanwhile, operation module 105 can be configured to receive inputs and commands from the user(s) of control system 100 via the electronic display of mobile electronic device 102, a numeric and/or alphanumeric keypad of mobile electronic device 102, a microphone of mobile electronic device 102, or any other suitable input mechanism of mobile electronic device 102. Likewise, operation module 105 can administer operation of the one of electricity transfer device 104 and the other electricity transfer device(s) of the device network by control system 100.

Specifically, control system 100 can comprise an executive mode and/or a subordinate mode. When control system 100 is operating as a primary control system, control system 100 can operate in the executive mode. When control system is operating as a secondary control system, control system 100 can operate in the subordinate mode. Meanwhile, control system 100 can operate as the primary control system when control system 100 presently has authorization to control the distribution of electricity from electricity transfer device 104. On the other hand, control system 100 can operate as the secondary control system when control system 100 does not presently have authorization to control the distribution of electricity from electricity transfer device 104. Whether control system 100 presently has authorization to control the distribution of electricity from electricity transfer device 104 is dependent on whether electricity transfer device 104 is configured to limit making available electricity to one rechargeable energy storage system at a time. Accordingly, while the managing entity of the device network may desire that only one of control system 100 (e.g., operating as the primary control system) be able to actually control electricity transfer device 104 at a time, it may still be desirable to permit one or more others of control system 100 (e.g., operating as second control system(s)) to operate other functions of electricity transfer device 104 (e.g., reservations, information retrieval, etc.) while such other(s) of control system 100 wait to achieve primary control system status. Assignment of primary and secondary control system status can be determined on any suitable basis, such as, on a first-come first-serve basis or by whether that particular one of control system 100 (and the user(s) thereof) presently has a reservation to use electricity transfer device 104.

Accordingly, when control system 100 is wirelessly communicating with electricity transfer device 104 and when control system 100 is operating in the executive mode, operation module 105 can be configured to permit user(s) of control system 100 (a) to control electricity transfer device 104 with control system 100 and (b) to monitor electricity transfer status (e.g., delivering electricity, ground fault detected, transfer completed, transfer interrupted, etc.) of electricity transfer device 104 at mobile electronic device 102 (e.g., via text message, via electronic mail, via telephone call, via control system interface 109, etc.) and/or to reserve use of electricity transfer device 104 (or one or more of the other electricity transfer device(s) of the device network) with control system 100. Meanwhile, when control system 100 is wirelessly communicating with electricity transfer device 104 and when control system 100 is operating in the subordinate mode, operation module 105 can be configured such that the user(s) of control system 100 are able to monitor the electricity transfer status (e.g., delivering electricity, transfer completed, transfer interrupted, etc.) of electricity transfer device 104 at mobile electronic device 102 (e.g., via text message, via electronic mail, via telephone call, via control system interface 109, etc.), and/or the user(s) of mobile electronic device 102 are able to reserve use of electricity transfer device 104 (or one or more of the other electricity transfer device(s) of the device network) with control system 100.

As mentioned previously, when control system 100 is operating as the primary control system, control system 100 does not necessarily have to maintain wireless communication with electricity transfer device 104 while electricity transfer device 104 is providing electricity to the rechargeable energy storage system of the electric vehicle of the user(s). For example, the user(s) could use control system 100 to setup electricity transfer between electricity transfer device 104 and the rechargeable energy storage system and then terminate wireless communication with electricity transfer device 104. Upon termination, electricity transfer device 104 can continue the electricity transfer according to any last received instructions or can manage the electricity transfer locally, such as with an electricity transfer device computer system of electricity transfer device 104, as described previously. The electricity transfer device computer system can be similar or identical to computer system 1008 (FIG. 10). Later, the user(s) can reconnect control system 100 to electricity transfer device 104 to provide additional instructions to electricity transfer device 104.

Operation module 105 can determine which of the information is appropriate for control system interface 109 to provide to the user(s). Operation module 105 can determine which of the information is appropriate based on data pertaining to the user(s) of control system 100 (e.g., provided by the user(s) and/or stored at the user account(s)), in response to inputs (e.g., reservation requests, charge requests, electricity transfer device status requests, etc.) provided to operation module 105 by the user(s), etc.

In some embodiments, the information can comprise electricity transfer device information and user information. The electricity transfer device information can comprise energy and demand information (e.g., energy costs, availability of alternative energy resources, etc.), device network information (e.g., availability and/or locations of electricity transfer device(s) of the device network, etc.), and/or user account information (e.g., billing details, etc.). Meanwhile, the user information can comprise marketing information (e.g., advertisements, public services announcements, etc.), social networking information (e.g., location indication, messaging with other user(s) of the device network, status updated, etc.), news information (e.g., current events, weather, traffic data, etc.), and/or governmental information (e.g., police reports, political messages, etc.).

Communication module 103 can be configured to receive at least part of the information from remote computer system 106 and/or electricity transfer device 104. Meanwhile, in some embodiments, operation module 105 can be configured to calculate/determine another part of the information at control system 100 using any of the at least part of the information provided to communication module 103 by remote compute system 106 and/or electricity transfer device 104. For example, communication module 103 may receive the costs of electricity throughout the day as energy and demand information from remote computer system 106, and operation module 105 may then calculate cost savings to the user(s) for transferring electricity at one time of the day versus another.

In some embodiments, operation module 105 may provide some of the information (e.g., marketing information) to the user(s) of mobile electronic device 102 at predetermined instances when the user(s) are operating electricity transfer device 104 with control system 100. In these embodiments, incentives (e.g., lower prices) might be offered to the user(s) of control system 100 in exchange for receiving the information (i.e., the marketing information) at their mobile electronic device 102. Furthermore, the enhanced functionality of mobile electronic device 102 (e.g., video capability, etc.) may permit more elaborate information (i.e., marketing information) to be provided to the user(s) than might be possible at electricity transfer device 104.

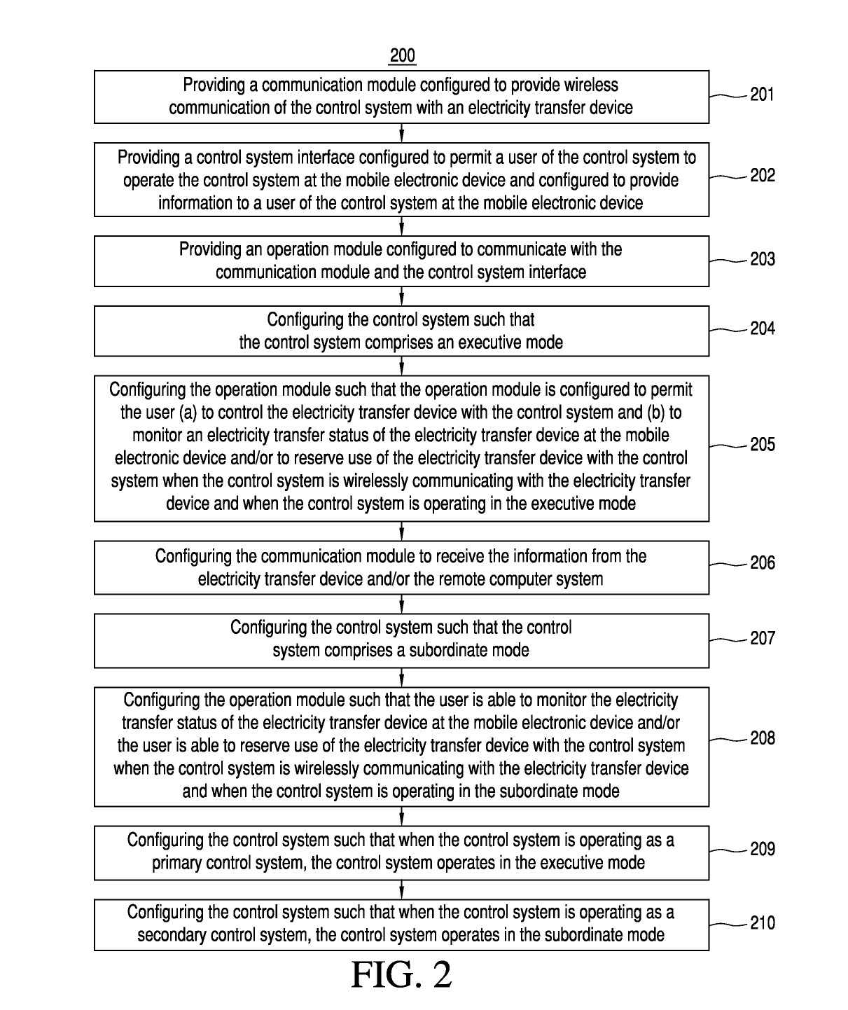

Returning again to the drawings, FIG. 2 illustrates a flow chart for an embodiment of method 200 for providing a control system. Method 200 is merely exemplary and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, the procedures, the processes, and/or the activities of method 200 can be performed in any other suitable order. In still other embodiments, one or more of the procedures, the processes, and/or the activities in method 200 can be combined or skipped.

The control system can be similar or identical to control system 100 (FIG. 1). For example, like control system 100 (FIG. 1), the control system of method 200 can be configured to be run on one or more processors of a mobile electronic device computer system of a mobile electronic device and storable at one or more memory storage units of the mobile electronic device computer system. Meanwhile, the mobile electronic device computer system can be similar or identical to mobile electronic device computer system 101 (FIG. 1), and the mobile electronic device can be similar or identical to mobile electronic device 102 (FIG. 1).

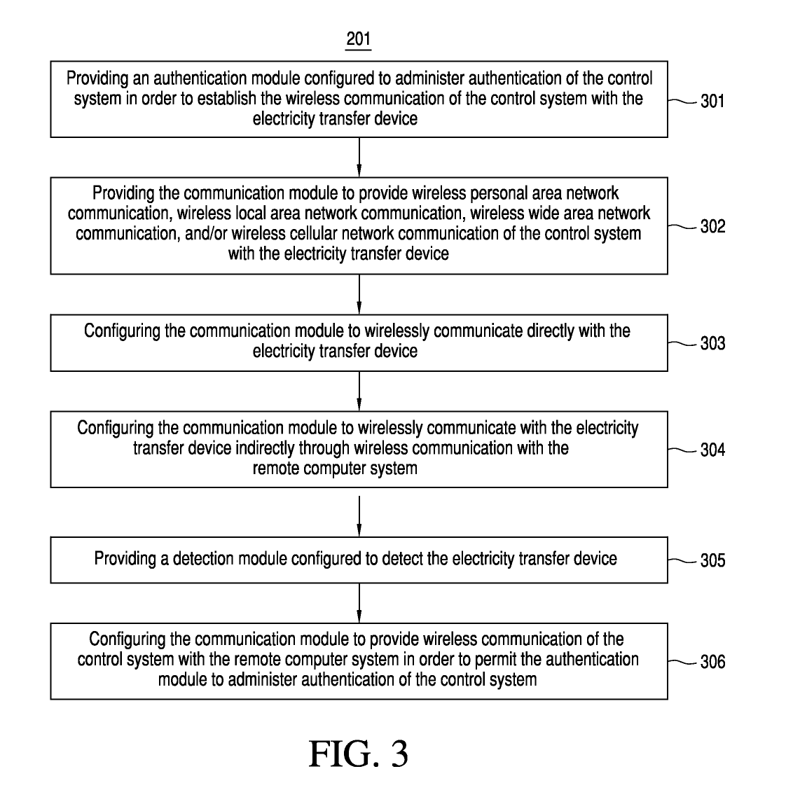

Method 200 can comprise procedure 201 of providing a communication module configured to provide wireless communication of the control system with an electricity transfer device. The communication module can be similar or identical to communication module 103 (FIG. 1), and the electricity transfer device can be similar or identical to electricity transfer device 104 (FIG. 1). FIG. 3 illustrates an exemplary procedure 201 of providing the communication module configured to provide wireless communication of the control system with the electricity transfer device, according to the embodiment of FIG. 2.

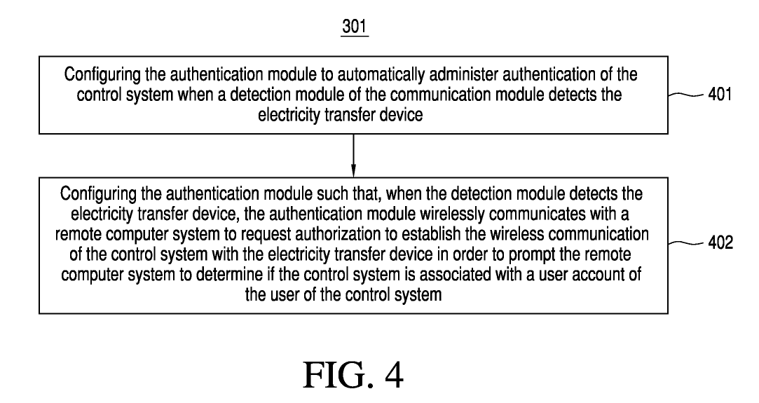

Referring to FIG. 3, procedure 201 can comprise process 301 of providing an authentication module configured to administer authentication of the control system in order to establish the wireless communication of the control system with the electricity transfer device. The authentication module can be similar or identical to authentication module 107 (FIG. 1). FIG. 4 illustrates an exemplary process 301 of providing the authentication module configured to administer authentication of the control system in order to establish the wireless communication of the control system with the electricity transfer device, according to the embodiment of FIGS. 2 and 3.

Referring to FIG. 4, process 301 can comprise activity 401 of configuring the authentication module to automatically administer authentication of the control system when a detection module of the communication module detects the electricity transfer device. In other embodiments, process 301 can comprise configuring the authentication module to partially automatically administer authentication or to administer authentication upon a manual request from the user(s) of the control system, as described above with respect to control system 100 (FIG. 1).

Process 301 also can comprise activity 402 of configuring the authentication module such that, when the detection module detects the electricity transfer device, the authentication module wirelessly communicates with a remote computer system to request authorization to establish the wireless communication of the control system with the electricity transfer device in order to prompt the remote computer system to determine if the control system is associated with a user account of the user of the control system. The remote computer system can be similar or identical to remote computer system 106 (FIG. 1). Likewise, the user account can be similar or identical to the user account described above with respect to control system 100 (FIG. 1).

Returning to FIG. 3, procedure 201 can comprise process 302 of providing the communication module to provide wireless personal area network communication, wireless local area network communication, wireless wide area network communication, and/or wireless cellular network communication of the control system with the electricity transfer device. Procedure 201 can additionally comprise process 303 of configuring the communication module to wirelessly communicate directly with the electricity transfer device. Furthermore, procedure 201 can comprise process 304 of configuring the communication module to wirelessly communicate with the electricity transfer device indirectly through wireless communication with the remote computer system. In some embodiments, when process 303 is performed, process 304 can be omitted, or vice versa. In still other embodiments, both process 303 and process 304 can be performed.

Procedure 201 can also comprise process 305 of providing a detection module configured to detect the electricity transfer device. The detection module can be similar or identical to detection module 108 (FIG. 1).

Procedure 201 can further comprise process 306 of configuring the communication module to provide wireless communication of the control system with the remote computer system in order to permit the authentication module to administer authentication of the control system.

Returning now to FIG. 2, method 200 can comprise procedure 202 of providing a control system interface configured to permit a user of the control system to operate the control system at the mobile electronic device and configured to provide information to a user of the control system at the mobile electronic device. The control system interface can be similar or identical to control system interface 109 (FIG. 1), and the information can be similar or identical to the information described above with respect to control system 100 (FIG. 1).

Method 200 can comprise procedure 203 of providing an operation module configured to communicate with the communication module and the control system interface. The operation module can be similar or identical to operation module 105 (FIG. 1).

Method 200 can comprise procedure 204 of configuring the control system such that the control system comprises an executive mode. The executive mode can be similar or identical to the executive mode described above with respect to the control system 100 (FIG. 1).

Method 200 can comprise procedure 205 of configuring the operation module such that the operation module is configured to permit the user (a) to control the electricity transfer device with the control system and (b) to monitor an electricity transfer status of the electricity transfer device at the mobile electronic device and/or to reserve use of the electricity transfer device with the control system when the control system is wirelessly communicating with the electricity transfer device and when the control system is operating in the executive mode. The electricity transfer status can be similar or identical to the electricity transfer status described above with respect to the executive mode of control system 100 (FIG. 1) and control system 100 generally.

Method 200 can comprise procedure 206 of configuring the communication module to receive the information from the electricity transfer device and/or the remote computer system.

Method 200 can comprise procedure 207 of configuring the control system such that the control system comprises a subordinate mode. The subordinate mode can be similar or identical to the subordinate mode described above with respect to control system 100 (FIG. 1).

Method 200 can comprise procedure 208 of configuring the operation module such that (a) the user is able to monitor the electricity transfer status of the electricity transfer device at the mobile electronic device and/or (b) the user is able to reserve use of the electricity transfer device with the control system when the control system is wirelessly communicating with the electricity transfer device and when the control system is operating in the subordinate mode. The electricity transfer status can be similar or identical to the electricity transfer status described above with respect to the subordinate mode of control system 100 (FIG. 1) and control system 100 generally.

Method 200 can comprise procedure 209 of configuring the control system such that, when the control system is operating as a primary control system, the control system operates in the executive mode. The primary control system can be similar or identical to the primary control system described above with respect to control system 100 (FIG. 1).

Method 200 can comprise procedure 210 of configuring the control system such that, when the control system is operating as a secondary control system, the control system operates in the subordinate mode. The secondary control system can be similar or identical to the secondary control system described above with respect to control system 100 (FIG. 1).

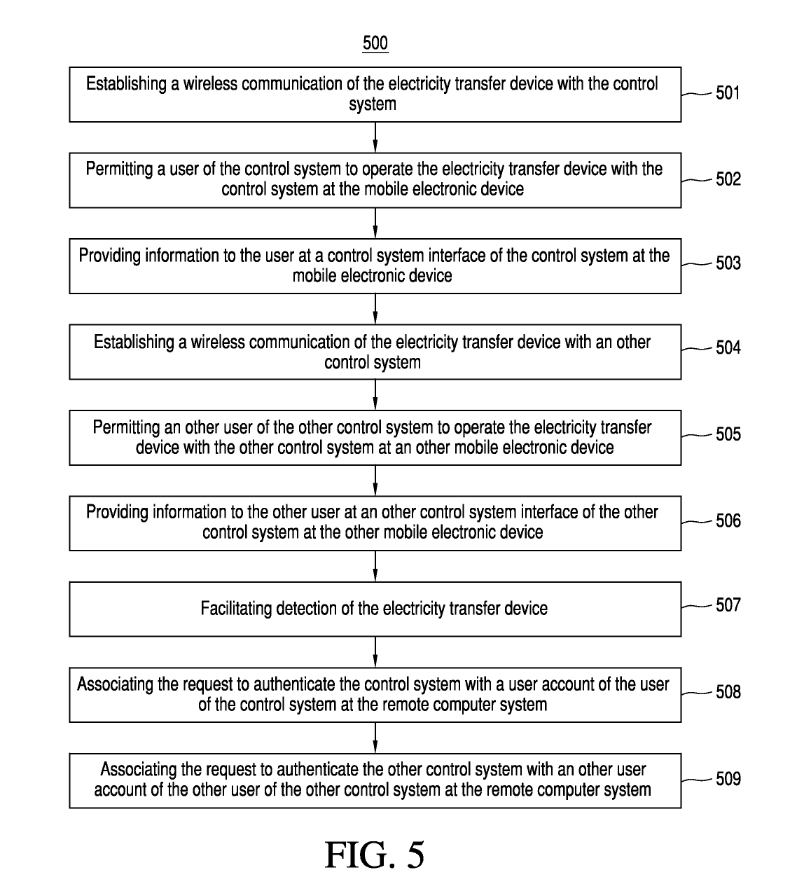

Skipping ahead in the drawings, FIG. 5 illustrates a flow chart for an embodiment of method 500 of operating an electricity transfer device. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any other suitable order. In still other embodiments, one or more of the procedures, the processes, and/or the activities in method 500 can be combined or skipped.

The electricity transfer device can be similar or identical to electricity transfer device 104 (FIG. 1). For example, the electricity transfer device can be configured to be controlled by a control system, where the control system can be similar or identical to control system 100 (FIG. 1). Accordingly, the control system can be configured to be run on one or more processors of a mobile electronic device computer system of a mobile electronic device and storable at one or more memory storage units of the mobile electronic device computer system. Meanwhile, the mobile electronic device computer system can be similar or identical to mobile electronic device computer system 101 (FIG. 1), and the mobile electronic device can be similar or identical to mobile electronic device 102 (FIG. 1).

Method 500 can comprise procedure 501 of establishing a wireless communication of the electricity transfer device with the control system. In some embodiments, procedure 501 can comprise receiving a request to authenticate the control system, such as, at the electricity transfer device or at a remote computer system. In many embodiments, procedure 501 of establishing the wireless communication of the electricity transfer device with the control system can be performed in a manner similar to that described above with respect to control system 100 (FIG. 1). The remote computer system can be similar or identical to remote computer system 106 (FIG. 1).

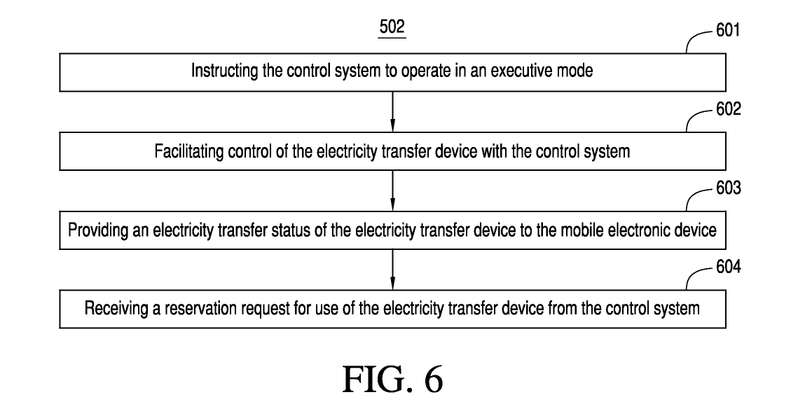

Method 500 can comprise procedure 502 of permitting a user of the control system to operate the electricity transfer device with the control system at the mobile electronic device. In many embodiments, procedure 502 can be performed after or approximately simultaneously with procedure 501. FIG. 6 illustrates an exemplary procedure 502 of permitting the user of the control system to operate the electricity transfer device with the control system at the mobile electronic device, according to the embodiment of FIG. 5.

Referring to FIG. 6, procedure 502 can comprise process 601 of instructing the control system to operate in an executive mode. In many embodiments, the executive mode can be similar or identical to the executive mode described above with respect to control system 100 (FIG. 1). In some embodiments, process 601 can comprise sending an instruction to the control system to operate in the executive mode from one of the electricity transfer device or the remote computer system.

Procedure 502 can comprise process 602 of facilitating control of the electricity transfer device with the control system. In some embodiments, process 602 can be performed after or approximately simultaneously with process 601, process 603, and/or process 604. In other embodiments, process 602 can be performed before process 603 and/or process 604.

Procedure 502 can comprise process 603 of providing an electricity transfer status of the electricity transfer device to the mobile electronic device. The electricity transfer status can be similar or identical to the electricity transfer status described above with respect to the executive mode of control system 100 (FIG. 1) and/or with respect to control system 100 generally. In some embodiments, process 603 can be performed after or approximately simultaneously with process 601, process 602, and/or process 604. In other embodiments, procedure 603 can be performed before process 602 and/or process 604.

Procedure 502 can comprise process 604 of receiving a reservation request for use of the electricity transfer device from the control system. The reservation request can be similar or identical to the reservation request described above with respect to control system 100 (FIG. 1). For example, process 604 can comprise receiving the reservation request for use of the electricity transfer device from the control system at the remote computer system. In some embodiments, process 604 can be performed after or approximately simultaneously with process 601, process 602, and/or process 603. In other embodiments, process 604 can be performed before process 602 and/or process 603.

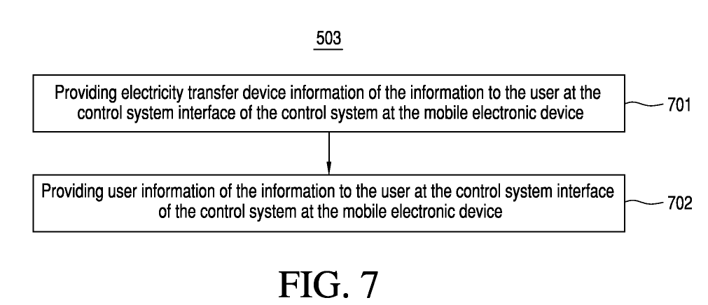

Referring back to FIG. 5, method 500 can comprise procedure 503 of providing information to the user at a control system interface of the control system at the mobile electronic device. In many embodiments, procedure 503 can be performed after or approximately simultaneously with procedure 501. In other embodiments, procedure 503 can be performed before, after, or approximately simultaneously with procedure 502. FIG. 7 illustrates an exemplary procedure 503 of providing the information to the user at the control system interface of the control system at the mobile electronic device, according to the embodiment of FIG. 5. Meanwhile, the control system interface can be similar or identical to control system interface 109 (FIG. 1), and the information can be similar or identical to the information described above with respect to control system 100 (FIG. 1).

Referring to FIG. 7, procedure 503 can comprise process 701 of providing electricity transfer device information of the information to the user at the control system interface of the control system at the mobile electronic device. The electricity transfer device information can be similar or identical to the electricity transfer device information described above with respect to control system 100 (FIG. 1).

Procedure 503 can comprise process 702 of providing user information of the information to the user at the control system interface of the control system at the mobile electronic device. The user information can be similar or identical to the user information described above with respect to control system 100 (FIG. 1).

Returning back to FIG. 5, method 500 can comprise procedure 504 of establishing a wireless communication of the electricity transfer device with an other control system. In some embodiments, procedure 504 can be performed after procedure 501, procedure 502, and/or procedure 503. In other embodiments, procedure 504 can be performed approximately simultaneously with procedure 502 and/or procedure 503. In various embodiments, procedure 504 can comprise receiving a request to authenticate the other control system, such as, at the electricity transfer device or at the remote computer system. In many embodiments, procedure 504 of establishing the wireless communication of the electricity transfer device with the other control system can be performed in a manner similar to that described above with respect to control system 100 (FIG. 1). Meanwhile, the other control system can also be similar or identical to control system 100 (FIG. 1).

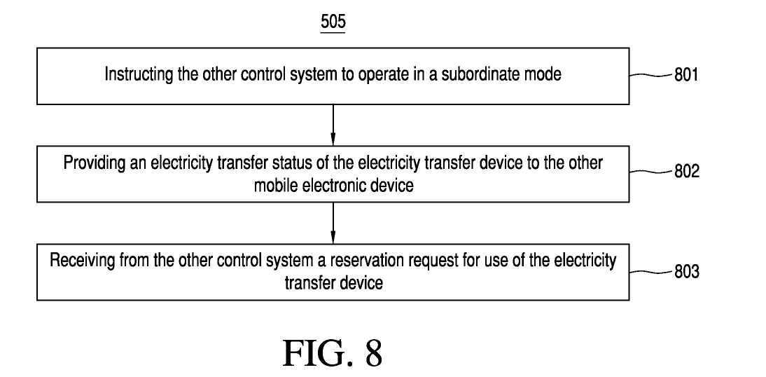

Method 500 can comprise procedure 505 of permitting an other user of the other control system to operate the electricity transfer device with the other control system at an other mobile electronic device. In some embodiments, procedure 505 can be performed after or approximately simultaneously with procedure 504. Meanwhile, procedure 505 can be performed after procedure 501, procedure 502, and/or procedure 503. Still further, procedure 505 can be performed approximately simultaneously with procedure 502 and/or procedure 503. FIG. 8 illustrates an exemplary procedure 505 of permitting the other user of the other control system to operate the electricity transfer device with the other control system at the other mobile electronic device, according to the embodiment of FIG. 5. The other mobile electronic device can be similar or identical to mobile electronic device 102 (FIG. 1).

Referring to FIG. 8, procedure 505 can comprise process 801 of instructing the other control system to operate in a subordinate mode. The subordinate mode can be similar or identical to the subordinate mode described above with respect to control system 100 (FIG. 1). In some embodiments, process 801 can comprise sending an other instruction to the other control system to operate in the subordinate mode from one of the electricity transfer device or the remote computer system.

Procedure 505 can comprise process 802 of providing an electricity transfer status of the electricity transfer device to the other mobile electronic device. The electricity transfer status can be similar or identical to the electricity transfer status described above with respect to the subordinate mode of control system 100 (FIG. 1) and/or with respect to control system 100 generally. In some embodiments, process 802 can be performed after or approximately simultaneously with process 801 and/or process 803. In other embodiments, procedure 802 can be performed before process 803.

Procedure 505 can comprise process 803 of receiving from the other control system a reservation request for use of the electricity transfer device. The reservation request can be similar or identical to the reservation request described above with respect to control system 100 (FIG. 1). For example, process 803 can comprise receiving the reservation request for use of the electricity transfer device from the control system at the remote computer system. In some embodiments, process 803 can be performed after or approximately simultaneously with process 801 and/or process 802. In other embodiments, process 803 can be performed before process 802.

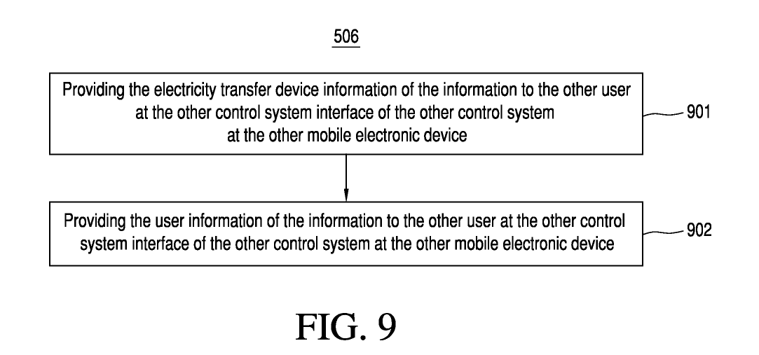

Returning to FIG. 5, method 500 can comprise procedure 506 of providing information to the other user at an other control system interface of the other control system at the other mobile electronic device. In some embodiments, procedure 506 can be performed after procedure 504. In other embodiments, procedure 506 can be performed before, after, or approximately simultaneously with procedure 505. FIG. 9 illustrates an exemplary procedure 506 of providing the information to the other user at the other control system interface of the other control system at the other mobile electronic device, according to the embodiment of FIG. 5. Procedure 503 can be performed before, after, or approximately simultaneously with procedure 502. Meanwhile, the other control system interface can be similar or identical to control system interface 109 (FIG. 1), and the information can be similar or identical to the information described above with respect to control system 100 (FIG. 1). Still, while the information of procedure 503 and procedure 506 may be similar with respect to each other, the information can differ in some respects as may be relevant to the control system and the other control system and the corresponding user(s) thereof. For example, the control system and the other control system may correspond to different user accounts, different geographic locations, different electricity transfer times, different electricity transfer preferences, different electricity costs, etc.

Referring to FIG. 9, procedure 506 can comprise process 901 of providing the electricity transfer device information of the information to the other user at the other control system interface of the other control system at the other mobile electronic device. The electricity transfer device information can be similar or identical to the electricity transfer device information described above with respect to control system 100 (FIG. 1).

Procedure 503 can comprise process 902 of providing the user information of the information to the other user at the other control system interface of the other control system at the other mobile electronic device. The user information can be similar or identical to the user information described above with respect to control system 100 (FIG. 1).

Referring back to FIG. 5, method 500 can comprise procedure 507 of facilitating detection of the electricity transfer device. In some embodiments, procedure 507 can comprise providing (e.g., emitting/outputting) a signal (e.g., a radio signal, a magnetic field, etc.) such that a detection module of the control system can detect the electricity transfer device. The detection module can be similar or identical to detection module 108 (FIG. 1).

Method 500 can comprise procedure 508 of associating the request to authenticate the control system with a user account of the user of the control system at the remote computer system. Likewise, method 500 can comprise procedure 509 of associating the request to authenticate the other control system with an other user account of the other user of the other control system at the remote computer system. Procedure 508 and/or procedure 509 each can be performed in a manner similar to that described above with respect to control system 100 (FIG. 1).

Turning to the drawings, FIG. 10 illustrates a representative block diagram of system 1000, according to an embodiment. System 1000 is merely exemplary and is not limited to the embodiments presented herein. System 1000 can be employed in many different embodiments or examples not specifically depicted or described herein.

System 1000 comprises electricity transfer device 1001 and authentication module 1005. Meanwhile, system 1000 can also comprise remote computer system 1004. Electricity transfer device 1001 can be configured to be operated by control system 1002. Accordingly, electricity transfer device 1001 can be similar or identical to electricity transfer device 104 (FIG. 1), and control system 1002 can be similar or identical to control system 100 (FIG. 1). For example, control system 1002 can be configured to be run on one or more processors of mobile electronic device computer system 1007 of mobile electronic device 1006 and storable at one or more memory storage units of mobile electronic device computer system 1007. Mobile electronic device computer system 1007 can be similar or identical to mobile electronic device computer system 101 (FIG. 1), and mobile electronic device 1006 can be similar or identical to mobile electronic device 102 (FIG. 1). Likewise, remote computer system 1004 can be similar or identical to remote computer system 106 (FIG. 1).

Electricity transfer device 1001 can comprise communication module 1003. Communication module 1003 can be configured to provide wireless communication of electricity transfer device 1001 with control system 1002. Communication module 1003 can be configured to implement a wireless network adapter (e.g., network adapter 1320 (FIG. 13)) of electricity transfer device computer system 1008 to provide wireless communication for electricity transfer device 1001, according to any suitable wireless networking protocol. Exemplary wireless networking protocols can be similar or identical to the exemplary wireless networking protocols described above with respect to control system 100 (FIG. 1). In other embodiments, communication module 1003 can implement any radio transceiver and/or infrared transceiver of electricity transfer device 1001 and/or electricity transfer device computer system 1008 to provide wireless communication for electricity transfer device 1001. In many embodiments, communication module 1003 can be configured to transfer seamlessly between one wireless networking protocol to another depending on the distance between electricity transfer device 1001 and control system 1002.

Electricity transfer device computer system 1008 can be configured to operate electricity transfer device 1001 in the absence of control system 1002. In some embodiments, control system 1002 can supplement electricity transfer device computer system 1008 in controlling electricity transfer device 1001, as described above with respect to control system 100 (FIG. 1). Electricity transfer device computer system 1008 can be configured to communicate with communication module 1003.

Authentication module 1005 can be configured to administer authentication of control system 1002. Authentication module 1005 can be located at electricity transfer device 1001 and/or at remote computer system 1004, when applicable. Authentication module 1005 can be configured to operate in a fashion complimentary to authentication module 107 (FIG. 1) of control system 100 (FIG. 1) such that authentication module 1005 can be configured to respond to authentication requests provided to authentication module 1005 by control system 1002. Accordingly, when authentication module 1005 receives a request to authorize control system 1002 at authentication module 1005, authentication module 1005 can be configured to administer authentication by determining if control system 1002 is associated with a user account of user(s) of control system 1002. Authentication module 1005 can be configured to communicate with communication module 1003, and vice versa. Authentication module 1005 can be configured to wirelessly communicate with communication module 1003 when authentication module 1005 is part of remote computer system 1004.

Electricity transfer device 1001 can be configured to be operable by user(s) of control system 1002 via control system 1002 when control system 1002 has been authenticated and when electricity transfer device 1001 is wirelessly communicating with control system 1002 in either one of an executive mode or a subordinate mode. The executive mode can be similar or identical to the executive mode, and the subordinate mode can be similar or identical to the subordinate mode, as each is described above with respect to control system 100 (FIG. 1).

Electricity transfer device 1001 and/or remote computer system 1004, when applicable, can be configured to provide information to the user(s) at control system interface 1009 of control system 1002 at mobile electronic device 1006 when control system 1002 has been authenticated and when electricity transfer device 1001 is wirelessly communicating with control system 1002 in either one of the executive mode or the subordinate mode. Control system interface 1009 can be similar or identical to control system interface 109 (FIG. 1).

Electricity transfer device 1001 can be configured such that when control system 1002 is operating in the executive mode, control system 1002 is able (a) to control electricity transfer device 1001, and control system 1002 is able to monitor electricity transfer status of electricity transfer device 1001 at mobile electronic device 1006 and/or (b) to reserve the use of electricity transfer device 1001 from control system 1002. Meanwhile, electricity transfer device 1001 can be configured such that when control system 1002 is operating in the subordinate mode, control system 1002 is able to monitor an electricity transfer status of electricity transfer device 1001 at mobile electronic device 1006 and/or to reserve use of electricity transfer device 1001 from control system 1002.

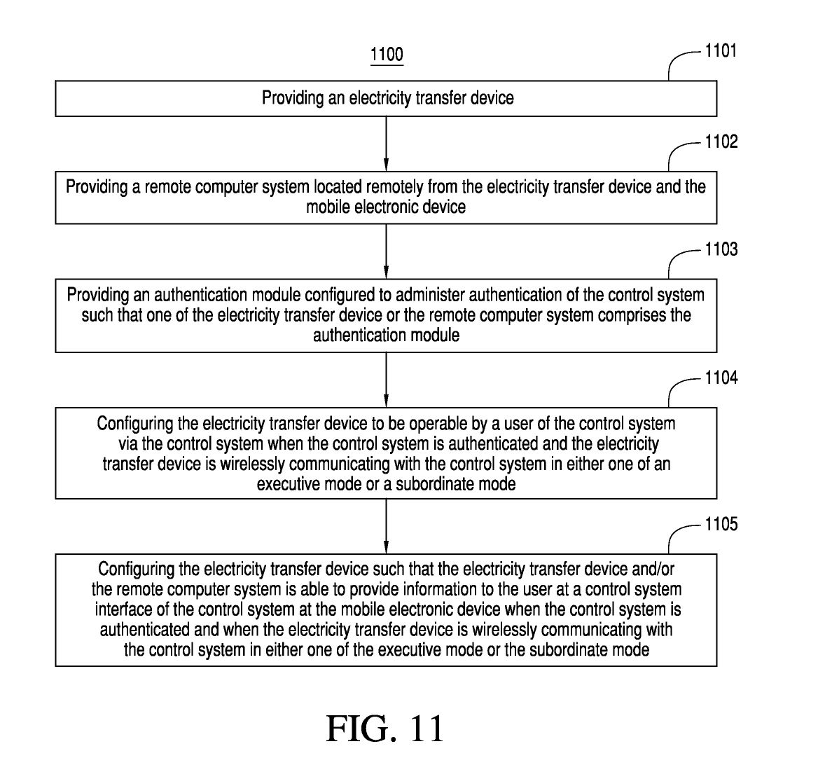

FIG. 11 illustrates a flow chart for an embodiment of method 1100 of providing a system. Method 1100 is merely exemplary and is not limited to the embodiments presented herein. Method 1100 can be employed in many different embodiments or examples not specifically depicted or described herein. In some embodiments, the procedures, the processes, and/or the activities of method 1100 can be performed in the order presented. In other embodiments, the procedures, the processes, and/or the activities of method 1100 can be performed in any other suitable order. In still other embodiments, one or more of the procedures, the processes, and/or the activities in method 1100 can be combined or skipped. The system can be similar or identical system 1000 (FIG. 10).

Method 1100 can comprise procedure 1101 of providing an electricity transfer device. The electricity transfer device can be similar or identical to electricity transfer device 104 (FIG. 1) and/or electricity transfer device 1001 (FIG. 10). For example, the electricity transfer device can be configured to be operated by a control system, and the control system can be similar or identical to control system 100 (FIG. 1) and/or control system 1002 (FIG. 10). Accordingly, the control system can be configured to be run on one or more processors of a mobile electronic device computer system of a mobile electronic device and storable at one or more memory storage units of the mobile electronic device computer system, and the electricity transfer device comprising a communication module configured to provide wireless communication of the electricity transfer device with the control system. The mobile electronic device computer system can be similar or identical to mobile electronic device computer system 101 (FIG. 1) and/or mobile electronic device computer system 1007 (FIG. 10). Likewise, the mobile electronic device can be similar or identical to mobile electronic device 102 (FIG. 1) and/or mobile electronic device 1006 (FIG. 10).

Method 1100 can comprise procedure 1102 of providing a remote computer system located remotely from the electricity transfer device and the mobile electronic device. The remote computer system can be similar or identical to remote computer system 106 (FIG. 1) and/or remote computer system 1004 (FIG. 10).

Method 1100 can comprise procedure 1103 of providing an authentication module configured to administer authentication of the control system such that one of the electricity transfer device or the remote computer system comprises the authentication module. The authentication module can be similar or identical to authentication module 107 (FIG. 1) and/or authentication module 1005 (FIG. 10).

Method 1100 can comprise procedure 1104 of configuring the electricity transfer device to be operable by a user of the control system via the control system when the control system is authenticated and the electricity transfer device is wirelessly communicating with the control system in either one of an executive mode or a subordinate mode. The executive mode can be similar or identical to the executive mode, and the subordinate mode can be similar or identical to the subordinate mode, as each is described above with respect to control system 100 (FIG. 1) and system 1000 (FIG. 10).

Method 1100 can comprise procedure 1105 of configuring the electricity transfer device such that the electricity transfer device and/or the remote computer system is able to provide information to the user at a control system interface of the control system at the mobile electronic device when the control system is authenticated and when the electricity transfer device is wirelessly communicating with the control system in either one of the executive mode or the subordinate mode. The control system interface can be similar or identical to control system interface 109 (FIG. 1) and/or control system interface 1009 (FIG. 10).

FIG. 12 illustrates an exemplary embodiment of computer system 1200, all of which or a portion of which can be suitable for implementing an embodiment of mobile electronic device computer system 101 (FIG. 1), remote computer system 106 (FIG. 1), mobile electronic device computer system 1007 (FIG. 10), remote computer system 1004 (FIG. 10), electricity transfer device computer system 1008 (FIG. 10), and/or another element of control system 100 (FIG. 1) and/or system 1000 (FIG. 10) as well as any of the various procedures, processes, and/or activities of method 500 (FIG. 5). As an example, a different or separate one of chassis 1202 (and its internal components) can be suitable for implementing mobile electronic device computer system 101 (FIG. 1), remote computer system 106 (FIG. 1), mobile electronic device computer system 1007 (FIG. 10), remote computer system 1004 (FIG. 10), and/or electricity transfer device computer system 1008 (FIG. 10). Furthermore, one or more elements of computer system 1200 (e.g., refreshing monitor 1206, keyboard 1204, and/or mouse 1210, etc.) may also be appropriate for implementing remote computer system 106 (FIG. 1) and/or remote computer system 1004 (FIG. 10). Computer system 1200 comprises chassis 1202 containing one or more circuit boards (not shown), Universal Serial Bus (USB) 1212, Compact Disc Read-Only Memory (CD-ROM) and/or Digital Video Disc (DVD) drive 1216, and hard drive 1214. A representative block diagram of the elements included on the circuit boards inside chassis 1202 is shown in FIG. 13. Central processing unit (CPU) 1310 in FIG. 13 is coupled to system bus 1314 in FIG. 13. In various embodiments, the architecture of CPU 1310 can be compliant with any of a variety of commercially distributed architecture families.

Turning to FIG. 13, system bus 1314 also is coupled to memory storage unit 1308, where memory storage unit 1308 comprises both read only memory (ROM) and random access memory (RAM). Non-volatile portions of memory storage unit 1308 or the ROM can be encoded with a boot code sequence suitable for restoring computer system 1200 (FIG. 12) to a functional state after a system reset. In addition, memory storage unit 1308 can comprise microcode such as a Basic Input-Output System (BIOS). In some examples, the one or more storage units of the various embodiments disclosed herein can comprise memory storage unit 1308, a USB-equipped electronic device, such as, an external memory storage unit (not shown) coupled to universal serial bus (USB) 1212 (FIGS. 12-13), hard drive 1214 (FIGS. 12-13), and/or CD-ROM or DVD drive 1216 (FIGS. 12-13). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows, Mac® operating system (OS), UNIX® OS, and Linux® OS. Other common operating systems can comprise the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 1310.

In the depicted embodiment of FIG. 13, various I/O devices such as disk controller 1304, graphics adapter 1324, video controller 1302, keyboard adapter 1326, mouse adapter 1306, network adapter 1320, and other I/O devices 1322 can be coupled to system bus 1314. Keyboard adapter 1326 and mouse adapter 1306 are coupled to keyboard 1204 (FIGS. 12-13) and mouse 1210 (FIGS. 12-13), respectively, of computer system 1200 (FIG. 12). While graphics adapter 1324 and video controller 1302 are indicated as distinct units in FIG. 13, video controller 1302 can be integrated into graphics adapter 1324, or vice versa in other embodiments. Video controller 1302 is suitable for refreshing monitor 1206 (FIGS. 12-13) to display images on a screen 1208 (FIG. 12) of computer system 1200 (FIG. 12). Disk controller 1304 can control hard drive 1214 (FIGS. 12-13), USB 1212 (FIGS. 12-13), and CD-ROM drive 1216 (FIGS. 12-13). In other embodiments, distinct units can be used to control each of these devices separately.

In some embodiments, network adapter 1320 can comprise and/or be implemented as a WNIC (wireless network interface controller) card (not shown) plugged or coupled to an expansion port (not shown) in computer system 1200 (FIG. 12). In other embodiments, the WNIC card can be a wireless network card built into computer system 1200 (FIG. 12). A wireless network adapter can be built into computer system 1200 by having wireless communication capabilities integrated into the motherboard chipset (not shown), or implemented via one or more dedicated wireless communication chips (not shown), connected through a PCI (peripheral component interconnector) or a PCI express bus of computer system 1200 (FIG. 12) or USB 1212 (FIG. 12). In other embodiments, network adapter 1320 can comprise and/or be implemented as a wired network interface controller card (not shown). Network adapter 1320 can be configured to provide wireless communication functionality to computer system 1200 (FIG. 12) via any suitable wireless network protocol including, for example, wireless personal area network (PAN) communication, wireless local area network (LAN) communication, wireless wide area network (WAN) communication, and/or wireless cellular network communication.

Although many other components of computer system 1200 (FIG. 12) are not shown, such components and their interconnection are well known to those of ordinary skill in the art. Accordingly, further details concerning the construction and composition of computer system 1200 and the circuit boards inside chassis 1202 (FIG. 12) are not discussed herein.

When computer system 1200 in FIG. 12 is running, program instructions stored on a USB-equipped electronic device connected to USB 1212, on a CD-ROM or DVD in CD-ROM and/or DVD drive 1216, on hard drive 1214, or in memory storage unit 1308 (FIG. 13) are executed by CPU 1310 (FIG. 13). A portion of the program instructions, stored on these devices, can be suitable for carrying out at least part of control system 100 (FIG. 1) and/or system 1000 (FIG. 10) as well as any of the various procedures, processes, and/or activities of method 500 (FIG. 5).

Although computer system 1200 is illustrated as a desktop computer in FIG. 12, there can be examples where computer system 1200 may take a different form factor while still having functional elements similar to those described for computer system 1200. In some embodiments, computer system 1200 may comprise a single computer, a single server, or a cluster or collection of computers or servers, or a cloud of computers or servers. Typically, a cluster or collection of servers can be used when the demand on computer system 1200 exceeds the reasonable capability of a single server or computer.

Meanwhile, in some embodiments, electricity transfer device computer system 1008 (FIG. 10) may not have the level of sophistication and/or complexity of mobile electronic device computer system 101 (FIG. 1) and/or mobile electronic device computer system 1007 (FIG. 10). Furthermore, any of electricity transfer device computer system 1008 (FIG. 10), mobile electronic device computer system 101 (FIG. 1), and/or mobile electronic device computer system 1007 (FIG. 10) may not have the level of sophistication and/or complexity of remote computer system 106 (FIG. 1) and/or remote computer system 1004 (FIG. 10) For example, any of electricity transfer device computer system 1008 (FIG. 10), mobile electronic device computer system 101 (FIG. 1), and/or mobile electronic device computer system 1007 (FIG. 10) may have only those processing capabilities and/or memory storage capabilities as are reasonably necessary to perform the functionality, described above with respect to electricity transfer device 104 (FIG. 1) and/or electricity transfer device 1001 (FIG. 10), and control system 100 (FIG. 1) and/or control system 1002 (FIG. 10), as applicable. In a more detailed example, electricity transfer device computer system 1008 (FIG. 10) could be implemented as a microcontroller comprising flash memory, or the like. Reducing the sophistication and/or complexity of any of electricity transfer device computer system 1008 (FIG. 10), mobile electronic device computer system 101 (FIG. 1), and/or mobile electronic device computer system 1007 (FIG. 10) can reduce the size and/or cost of implementing electricity transfer device 104 (FIG. 1)/electricity transfer device 1001 (FIG. 10) and control system 100 (FIG. 1)/control system 1002 (FIG. 10), as applicable. Nonetheless, in other embodiments, any of electricity transfer device computer system 1008 (FIG. 10), mobile electronic device computer system 101 (FIG. 1), and/or mobile electronic device computer system 1007 (FIG. 10) may need additional sophistication and/or complexity to operate as desired.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 201 through 210 of FIG. 2, processes 301 through 306 of FIG. 3, activities 401 and 402 of FIG. 4, procedures 501 through 509 of FIG. 5, processes 601 through 604 of FIG. 6, processes 701 and 702 of FIG. 7, processes 801 through 803 of FIG. 8, processes 901 and 902 of FIG. 9, and procedures 1101 through 1105 of FIG. 11 may be comprised of many different procedures, processes, and activities and be performed by many different modules, in many different orders, that any element of FIGS. 1-13 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A control system configured to be run on one or more processors of a mobile electronic device computer system of a mobile electronic device and storable at one or more memory storage units of the mobile electronic device computer system, the control system comprising:
a communication module configured to provide wireless communication of the control system with an electricity transfer device, the communication module comprising an authentication module configured to administer authentication of the control system in order to establish the wireless communication of the control system with the electricity transfer device; and
a control system interface configured to permit a user of the control system to operate the control system at the mobile electronic device and further configured to provide information to the user of the control system at the mobile electronic device;
wherein:
the control system comprises an executive mode and is configured to permit the user (a) to control the electricity transfer device and (b) at least one of (i) to monitor an electricity transfer status of the electricity transfer device at the mobile electronic device or (ii) to reserve use of the electricity transfer device with the control system, when the control system is wirelessly communicating with the electricity transfer device and when the control system is operating in the executive mode.

2) The control system of claim 1 wherein:
the electricity transfer device comprises an electric vehicle charging station configured to transfer electricity between a rechargeable energy storage system of an electric vehicle and a utility electric grid.

3) The control system of claim 1 wherein:
the wireless communication of the control system with the electricity transfer device comprises at least one of wireless personal area network communication, wireless local area network communication, wireless wide area network communication, or wireless cellular network communication.

4) The control system of claim 1 wherein at least one of:
the communication module is configured to wirelessly communicate directly with the electricity transfer device; or
the communication module is configured to wirelessly communicate with the electricity transfer device indirectly through wireless communication with a remote computer system that is located remotely from the electricity transfer device and the mobile electronic device.

5) The control system of claim 1 wherein:
the communication module comprises a detection module configured to detect the electricity transfer device; and
the authentication module is configured to automatically administer authentication of the control system when the detection module detects the electricity transfer device.

6) The control system of claim 1 wherein:
the communication module is configured to provide wireless communication of the control system with a remote computer system in order to permit the authentication module to administer authentication of the control system, the remote computer system being located remotely from the electricity transfer device and the mobile electronic device.

7) The control system of claim 6 wherein:
the communication module comprises a detection module configured to detect the electricity transfer device; and
when the detection module detects the electricity transfer device, the authentication module is configured to wirelessly communicate with the remote computer system to request authorization to establish the wireless communication of the control system with the electricity transfer device in order to prompt the remote computer system to determine if the control system is associated with a user account of the user of the control system.

8) The control system of claim 1 wherein:
the information comprises electricity transfer device information and user information;
the electricity transfer device information comprises at least one of energy and demand information, network information, or user account information; and
the user information comprises at least one of marketing information, social networking information, news information, or governmental information.

9) The control system of claim 8 wherein:
the communication module is configured to provide wireless communication of the control system with a remote computer system located remotely from the electricity transfer device and the mobile electronic device; and
the communication module is configured to receive the information from at least one of the remote computer system or the electricity transfer device.

10) The control system of claim 1 wherein:
the control system operates as application software of the mobile electronic device computer system.

11) The control system of claim 1 wherein:
the control system comprises a subordinate mode and is configured such that at least one of (a) the user is able to monitor the electricity transfer status of the electricity transfer device at the mobile electronic device or (b) the user is able to reserve use of the electricity transfer device with the control system, when the control system is wirelessly communicating with the electricity transfer device and when the control system is operating in the subordinate mode;
when the control system is operating as a primary control system, the control system operates in the executive mode; and
when the control system is operating as a secondary control system, the control system operates in the subordinate mode.

12) The control system of claim 1 wherein:
the mobile electronic device comprises any one of a smart mobile telephone, a tablet computer system, a laptop computer system, or an electric vehicle computer system.

13) The control system of claim 1 wherein:
the electricity transfer device comprises an electric vehicle charging station configured to transfer electricity between a rechargeable energy storage system of an electric vehicle and a utility electric grid;
the wireless communication of the control system with the electricity transfer device comprises at least one of wireless personal area network communication, wireless local area network communication, wireless wide area network communication, or wireless cellular network communication;
the communication module comprises a detection module configured to detect the electricity transfer device;
the authentication module is configured to automatically administer authentication of the control system when the detection module detects the electricity transfer device;
the communication module is configured to provide wireless communication of the control system with a remote computer system in order to permit the authentication module to administer authentication of the control system, the remote computer system being located remotely from the electricity transfer device and the mobile electronic device;
when the detection module detects the electricity transfer device, the authentication module is configured to wirelessly communicate with the remote computer system to request authorization to establish the wireless communication of the control system with the electricity transfer device in order to prompt the remote computer system to determine if the control system is associated with a user account of the user of the control system;
the information comprises electricity transfer device information and user information;
the electricity transfer device information comprises at least one of energy and demand information, network information, or user account information;
the user information comprises at least one of marketing information, social networking information, news information, or governmental information;
the communication module is configured to receive the information from at least one of the remote computer system or the electricity transfer device;
the control system comprises a subordinate mode;
the control system is configured such that at least one of (a) the user is able to monitor the electricity transfer status of the electricity transfer device with the control system or (b) the user is able to reserve use of the electricity transfer device with the control system, when the control system is wirelessly communicating with the electricity transfer device and when the control system is operating in the subordinate mode;
when the control system is operating as a primary control system, the control system operates in the executive mode;
when the control system is operating as a secondary control system, the control system operates in the subordinate mode; and
the mobile electronic device comprises a smart mobile telephone.

14) A method for providing a control system, the control system being configured to be run on one or more processors of a mobile electronic device computer system of a mobile electronic device and storable at one or more memory storage units of the mobile electronic device computer system, the method comprising:
providing a communication module configured to provide wireless communication of the control system with an electricity transfer device, wherein providing the communication module comprises providing an authentication module configured to administer authentication of the control system in order to establish the wireless communication of the control system with the electricity transfer device;
providing a control system interface configured to permit a user of the control system to operate the control system at the mobile electronic device and further configured to provide information to the user of the control system at the mobile electronic device; and
configuring the control system to comprise an executive mode to permit the user (a) to control the electricity transfer device with the control system and (b) at least one of (i) to monitor an electricity transfer status of the electricity transfer device at the mobile electronic device or (ii) to reserve use of the electricity transfer device with the control system, when the control system is wirelessly communicating with the electricity transfer device and when the control system is operating in the executive mode.

15) The method of claim 14 wherein:
the electricity transfer device comprises an electric vehicle charging station configured to transfer electricity between a rechargeable energy storage system of an electric vehicle and a utility electric grid.

16) The method of claim 14 wherein:
providing the communication module comprises:
providing the communication module to provide at least one of wireless personal area network communication, wireless local area network communication, wireless wide area network communication, or wireless cellular network communication of the control system with the electricity transfer device.

17) The method of claim 14 wherein:
providing the communication module comprises at least one of:
configuring the communication module to wirelessly communicate directly with the electricity transfer device; or
configuring the communication module to wirelessly communicate with the electricity transfer device indirectly through wireless communication with a remote computer system that is located remotely from the electricity transfer device and the mobile electronic device.

18) The method of claim 14 wherein:
providing the communication module comprises:
providing a detection module configured to detect the electricity transfer device; and
providing the authentication module comprises:
configuring the authentication module to automatically administer authentication of the control system when the detection module detects the electricity transfer device.

19) The method of claim 14 wherein:
providing the communication module comprises:
configuring the communication module to provide wireless communication of the control system with a remote computer system in order to permit the authentication module to administer authentication of the control system, the remote computer system being located remotely from the electricity transfer device and the mobile electronic device.

20) The method of claim 19 wherein:
providing the communication module comprises:
providing a detection module configured to detect the electricity transfer device; and
providing the authentication module comprises:
configuring the authentication module such that when the detection module detects the electricity transfer device, the authentication module wirelessly communicates with the remote computer system to request authorization to establish the wireless communication of the control system with the electricity transfer device in order to prompt the remote computer system to determine if the control system is associated with a user account of the user of the control system.

21) The method of claim 14 further comprising:
configuring the communication module to receive the information from at least one of the electricity transfer device or a remote computer system, the remote computer system being located remotely from the electricity transfer device and the mobile electronic device;
wherein:
the information comprises electricity transfer device information and user information;
the electricity transfer device information comprises at least one of energy and demand information, network information, or user account information; and
the user information comprises at least one of marketing information, social networking information, news information, or governmental information.

22) The method of claim 14 further comprising:
configuring the control system such that the control system comprises a subordinate mode and is configured such that at least one of (a) the user is able to monitor the electricity transfer status of the electricity transfer device at the mobile electronic device or (b) the user is able to reserve use of the electricity transfer device with the control system, when the control system is wirelessly communicating with the electricity transfer device and when the control system is operating in the subordinate mode;
configuring the control system such that when the control system is operating as a primary control system, the control system operates in the executive mode; and
configuring the control system such that when the control system is operating as a secondary control system, the control system operates in the subordinate mode.

23) The method of claim 14 wherein:
the mobile electronic device comprises any one of a smart mobile telephone, a tablet computer system, a laptop computer system, or an electric vehicle computer system.

24) A method of operating an electricity transfer device, the electricity transfer device being configured to be controlled by a control system and the control system being configured to be run on one or more processors of a mobile electronic device computer system of a mobile electronic device and storable at one or more memory storage units of the mobile electronic device computer system, the method comprising:
establishing wireless communication of the electricity transfer device with the control system, wherein establishing wireless communication of the electricity transfer device with the control system comprises receiving a request to authenticate the control system;
after establishing wireless communication of the electricity transfer device with the control system, permitting a user of the control system to operate the electricity transfer device with the control system at the mobile electronic device, wherein permitting the user of the control system to operate the electricity transfer device comprises instructing the control system to operate in an executive mode; and
after establishing wireless communication of the electricity transfer device with the control system, providing information to the user at a control system interface of the control system at the mobile electronic device.

25) The method of claim 24 wherein:
permitting the user of the control system to operate the electricity transfer device comprises:
facilitating control of the electricity transfer device with the control system; and
at least one of:
providing an electricity transfer status of the electricity transfer device to the mobile electronic device; or
receiving a reservation request for use of the electricity transfer device from the control system.

26) The method of claim 24 further comprising:
establishing wireless communication of the electricity transfer device with an other control system while the control system operates the electricity transfer device, wherein establishing wireless communication of the electricity transfer device with the other control system comprises receiving a request to authenticate the other control system;
after establishing wireless communication of the electricity transfer device with the other control system, permitting an other user of the other control system to operate the electricity transfer device with the other control system at an other mobile electronic device while the control system operates the electricity transfer device, wherein permitting the other user of the other control system to operate the electricity transfer device comprises instructing the other control system to operate in a subordinate mode; and
after establishing wireless communication of the electricity transfer device with the other control system, providing other information to the other user at an other control system interface of the other control system at the other mobile electronic device while the control system operates the electricity transfer device.

27) The method of claim 26 wherein:
permitting the other user of the other control system to operate the electricity transfer device comprises at least one of:
providing an electricity transfer status of the electricity transfer device to the other mobile electronic device; or
receiving a reservation request for use of the electricity transfer device from the other control system.

28) The method of claim 24 further comprising at least one of:
facilitating detection of the electricity transfer device; or
associating the request to authenticate the control system with a user account of the user of the control system at a remote computer system located remotely from the electricity transfer device and the mobile electronic device.

29) The method of claim 24 wherein:
providing the information to the user at the control system interface of the control system at the mobile electronic device comprises:
providing electricity transfer device information of the information to the user at the control system interface of the control system at the mobile electronic device, the electricity transfer device information comprising at least one of energy and demand information, network information, or user account information; and
providing user information of the information to the user at the control system interface of the control system at the mobile electronic device, the user information comprises at least one of marketing information, social networking information, news information, or governmental information.

30) A system comprising:
an electricity transfer device, the electricity transfer device being configured to be operated by a control system, the control system being configured to be run on one or more processors of a mobile electronic device computer system of a mobile electronic device and storable at one or more memory storage units of the mobile electronic device computer system, and the electricity transfer device comprising a communication module configured to provide wireless communication of the electricity transfer device with the control system;
a remote computer system located remotely from the electricity transfer device and the mobile electronic device; and
an authentication module configured to administer authentication of the control system;
wherein:
the authentication module is located at one of the electricity transfer device or the remote computer system;
the electricity transfer device is configured to be operable by a user of the control system via the control system when the control system is authenticated and when the electricity transfer device is wirelessly communicating with the control system; and
at least one of the electricity transfer device or the remote computer system is configured to provide information to the user at a control system interface of the control system at the mobile electronic device when the control system is authenticated and when the electricity transfer device is wirelessly communicating with the control system.

31) The system of claim 30 wherein:
the control system operates in either one of an executive mode or a subordinate mode.

32) The system of claim 31 further comprising:
the control system.

33) The system of claim 31 wherein:
the electricity transfer device is configured such that when the control system is operating in the executive mode, the control system is able to control the electricity transfer device and at least one of the (a) control system is able to monitor electricity transfer status of the electricity transfer device at the mobile electronic device or (b) the control system is able to reserve use of the electricity transfer device from the control system; and
the electricity transfer device is configured such that when the control system is operating in the subordinate mode, at least one of (a) the control system is able to monitor an electricity transfer status of the electricity transfer device at the mobile electronic device or (b) the control system is able to reserve use of the electricity transfer device from the control system.

34) The system of claim 30 wherein at least one of:
the electricity transfer device comprises an electric vehicle charging station configured to transfer electricity between a rechargeable energy storage system of an electric vehicle and a utility electric grid;
the wireless communication of the electricity transfer device with the control system comprises at least one of wireless personal area network communication, wireless local area network communication, wireless wide area network communication, or wireless cellular network communication;
when the authentication module receives a request to authorize the control system at the authentication module, the authentication module is configured to administer authentication by determining if the control system is associated with a user account of the user of the control system; or
the information comprises (a) electricity transfer device information, the electricity transfer device information comprising at least one of energy and demand information, network information, or user account information, and (b) user information, the user information comprising at least one of marketing information, social networking information, news information, or governmental information.

35) The system of claim 30 further comprising:
the control system.

36) The system of claim 35 further comprising:
the mobile electronic device.

37) The system of claim 30 wherein:
the electricity transfer device is devoid of a user interface for controlling the electricity transfer device.

38) A method of providing a system, the method comprising:
providing an electricity transfer device, the electricity transfer device being configured to be operated by a control system, the control system being configured to be run on one or more processors of a mobile electronic device computer system of a mobile electronic device and storable at one or more memory storage units of the mobile electronic device computer system, and the electricity transfer device comprising a communication module configured to provide wireless communication of the electricity transfer device with the control system;
providing a remote computer system located remotely from the electricity transfer device and the mobile electronic device;
providing an authentication module configured to administer authentication of the control system such that one of the electricity transfer device or the remote computer system comprises the authentication module;
configuring the electricity transfer device to be operable by a user of the control system via the control system when the control system is authenticated and when the electricity transfer device is wirelessly communicating with the control system in either one of an executive mode or a subordinate mode; and
configuring the electricity transfer device such that at least one of the electricity transfer device or the remote computer system is able to provide information to the user at a control system interface of the control system at the mobile electronic device when the control system is authenticated and when the electricity transfer device is wirelessly communicating with the control system in either one of the executive mode or the subordinate mode.
